(19) United States
(12) Patent Application Publication
(10) Pub. No.: US 2004/0115122 A1
(43) Pub. Date: Jun. 17, 2004

(54) Method for preparing high quality barium-titanate based powder

(76) Inventors: Jae Chul Jung, Daejeon (KR); Woo Young Yang, Daejeon (KR); Keon Il Kim, Daejeon (KR); Yun Jung Park, Daejeon (KR); Jun Hee Lee, Daejeon (KR); Kang Heon Hur, Kyunggi-do (KR); Jai Joon Lee, Kyunggi-do (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/468,468

(22) PCT Filed: Feb. 5, 2002
(86) PCT No.: PCT/KR02/00165

(30) Foreign Application Priority Data
Feb. 22, 2001 (KR) 2001/9066

(51) Int. Cl. C01G 23/04

(52) U.S. Cl. 423/598

(57) ABSTRACT

The present invention relates to a method for preparing high quality barium titanate powder by precipitating barium titanyl oxalate with spraying a mixture of an aqueous barium chloride and titanium tetrachloride (TiCl₄) to an aqueous solution of oxalic acid via a nozzle in high speed, which exhibits improved yield with shortened reaction time and optimized stoichiometric mole ratio of barium to titanium, thus suitable materials for multilayer ceramic capacitors, PTC thermistors, resistors, and the like.

### BACKGROUND OF THE INVENTION

### FIELD OF INVENTION

The present invention relates to a method for preparing barium titanate powder of high quality. More particularly, the present invention provides a method for preparing barium titanate powder by precipitating barium titanyl oxalate (BaTiO(C₂O₄)₂4H₂O) with spraying a mixture of an aqueous barium chloride (BaCl₂2H₂O) and titanium tetrachloride (TiCl₄) to an aqueous solution of oxalic acid, via a nozzle in high speed. The method of the present invention exhibits improved yield with shortened reaction time and optimized stoichiometric mole ratio of barium to titanium compared to conventional oxalate method, thus the obtained barium titanate powder may be widely utilized to produce multi-layer ceramic chip capacitors(MLCC), positive temperature coefficient thermistors, resistors, and the like..

It is well-known that barium titanate powder can be manufactured via solid state reaction of barium carbonate (BaCO₃) and titanium dioxide (TiO₂) at high temperature. As the trend in MLCC(multi-layer ceramic chip capacitor) continues towards further and further miniaturization with large capacity, calcination at a low temperature, high frequency, and volumetric efficiency, the demand for not only finer and more uniform barium titanate powders has increased tremendously, but the need for purity and stoichiometric mole ratio of barium to titanium has also escalated as well. Thus, various liquid state reaction methods such as hydrothermal method, co-precipitation (oxalate) method, and alkoxide method have been developed to produce barium titanate powders satisfying these characteristics.

Among these, the oxalate method is well discussed by W. S. Clabaugh et al. in Journal of Research of the National Bureau of Standards, Vol. 56(5), 289-291(1956) to produce barium titanate by precipitating barium titanyl oxalate with addition of a mixture solution containing Ba and Ti ions to an oxalic acid. In this manufacturing process, barium titanyl oxalate is precipitated by the addition of a mixture of an aqueous solution of titanium tetrachloride and barium chloride, which is mixed in 1:1 mole ratio of Ba to Ti, to an aqueous solution of oxalic acid while stirring vigorously as shown in Scheme 1. The barium titanyl oxalate is filtered, washed, dried and pyrolized at 800-900° C. to convert it to barium titanate as shown in Schemes 2-4.

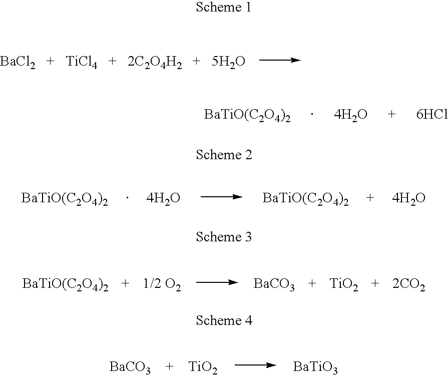

However, this method has several drawbacks: (i) it is difficult to control particle size and stoichiometric mole ratio of Ba to Ti; (ii) hard aggregates between particles are formed during the pyrolysis, thus requiring strong pulverization to remove these hard aggregates; (iii) because extremely fine particles are enormously produced during the strong pulverizing, it is hard to disperse the powder for forming and abnormal grain growth occur during sintering process. Above all, if the mixture solution of barium chloride and titanium tetrachloride is added rapidly to the oxalic acid even with vigorous stirring; it tends to yield barium titanyl oxalate having non-stoichiometric mole ratio of Ba/Ti, as shown in Table 1. This result is due to partial decrease in optimum concentration of oxalic acid at a dropping point. Thus, it produces barium titanate powders having undesirable morphology. On the other hand, when the mixture solution is added for a long period of time to overcome such problems, productivity becomes low. Additionally, the manufacturing yield is low(ca 80% based on Ti ions) in this conventional oxalate method. The barium titanate powders produced in this manner, having particle size of from several tens to several hundreds μm and agglomerating strongly as shown in FIG. 1, are not adequate for the applications to multilayer ceramic capacitors.

TABLE 1
Changes in mole ratio with an addition rate (4 L scale)

| | | | | |
|---|---|---|---|---|
| Addition rate | 2 | 8 | 20 | 40 |
| (mL/min) | | | | |
| Mole ratio | 1.000 | 0.998 | 0.921 | 0.482 |
| (Ba/Ti)* | | | | |

*Mole ratio is measured by XRF

Recently, hydrothermal method has been given attention to because of the trend of thinner and higher layered dielectric layer in MLCC. However, This method has disadvantages, like high manufacturing cost and complex process, due to use of autoclave, in spite of its high product quality. Therefore, there are increasing demands for developing simpler methods for preparing barium titanate powders in low price to be competitive in the market.

To overcome such deficiencies in poor processability and low product yield associated with the Clabaugh's oxalate process, Japan Patent No. 2-289426 has disclosed that powders are prepared by showering a mixture of barium chloride and titanium tetrachloride to an oxalic acid solution which is kept at a temperature of 55-75° C. in 88.3% based on Ti ions, where the stoichiometric mole ratio of Ba to Ti of barium titanyl oxalate is 0.999. By showering method for addition, it is meant that the end portion of pipe has 200 holes and a mixture solution is passed through those holes to improve production yield and reaction time. Even the production yield and reaction time were improved somewhat, it was still unsatisfactory to be commercialized.

### SUMMARY OF THE INVENTION

The present invention provides a method for preparing barium titanate powder having stoichiometric composition and less aggregated morphology. This is accomplished by spraying a mixture of barium chloride and titanyl tetrachloride to an aqueous solution of oxalic acid via a nozzle in high speed to precipitate barium titanyl oxalate having stoichiometric mole ratio of barium to titanium within short time in high yield. The barium titanyl oxalate is then pulverized, pyrolized, and re-pulverized to produce desired barium titanate powders.

Accordingly, an object of the present invention is to provide barium titanate powder which exhibits excellent physical properties and processability.

### BRIEF DESCRIPTION OF THE INVENTION

The above object of the present invention will become apparent from the following description of the invention, when taken in conjunction with the accompanying drawings, in which:

FIG. 1 represents SEM photomicrograph of barium titanate powder produced by the Clabaugh's conventional oxalate method;

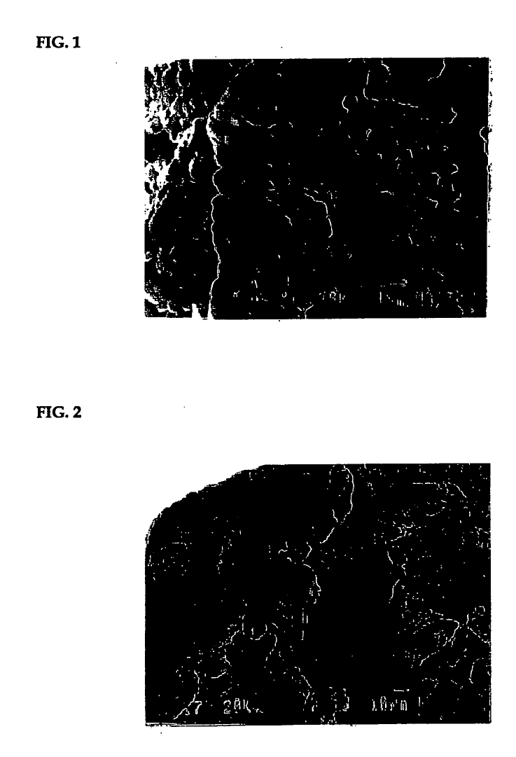

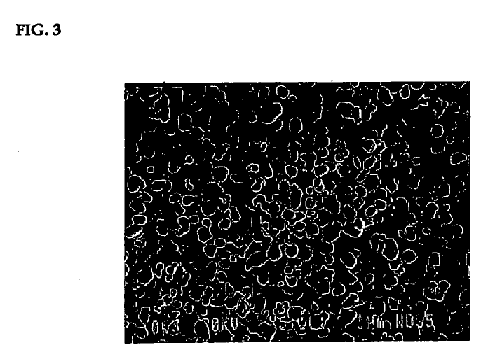

FIG. 2 represents SEM photomicrograph of barium titanyl oxalate produced by spraying via a single-fluid nozzle in a high speed, and filtering and washing;

FIG. 3 represents SEM photomicrograph of barium titanate powder produced by the method of present invention.

### DETAILED DESCRIPTION OF THE INVENTION

The present invention is described in more detail as set forth hereunder. The present invention provides a method for preparing barium titanate powder comprising the steps of:

precipitating barium titanyl oxalate (BaTiO(C₂O₄)₂4H₂O) by spraying of a mixture of an aqueous barium chloride (BaCl₂4H₂O) and titanium tetrachloride (TiCl₄) to an aqueous solution of oxalic acid, via a nozzle in high speed and aging, filtering and washing the same;

pulverizing the obtained barium titanyl oxalate, drying, pyrolizing to produce barium titanate (BaTiO₃) powder; and

re-pulverizing the pre-pulverized barium titanate powder.

In the conventional oxalate method as discussed above when a mixture solution is rapidly added to an oxalic acid, it yields barium titanyl oxalate having non-stoichiometric mole ratio of Ba to Ti, due to partial decrease in optimum concentration of oxalic acid at a dropping point. However, the spraying method via a nozzle in high speed helps to obtain barium titanyl oxalate having optimized stoichiometric mole ratio of Ba to Ti in high yield. Further, the method of the present invention produces barium titanate powder of high quality with homogeneous particle size during pyrolizing at a high temperature.

In the present invention, fluid through nozzle is sprayed at a flow rate of 0.01 to 70 l/min. Both single-fluid nozzle and double-fluid nozzle may be used but the use of single-fluid nozzle is more preferable. Examples of the single-fluid nozzle include full-con, hollow-con and flat.

In the first pulverization of the barium titanyl oxalate, additives may be added to replace Ba, Ti or both Ba and Ti with other elements, wherein the other element to replace Ba is at least one element chosen from Mg, Ca, Sr, and Pb and to replace Ti is at least one element chosen from Zr, Hf, and Sn. It is preferable to use an oxide, carbonate, chloride or nitrate of such a replacement element as an additive to replace Ba, Ti or both Ba and Ti.

The present invention will become apparent from the following description of the invention, when the process for preparing barium titanate powder is described step by step.

The first step is precipitation of barium titanyl oxalate with spraying a mixture of an aqueous barium chloride and titanium tetrachloride to an aqueous solution of oxalic acid via a nozzle in high speed, aging, washing with water, and filtration process. The aqueous barium chloride is prepared by dissolving barium chloride dihydrate (BaCl₂2H₂O) in water, and preferable barium chloride concentration is in the range of from 0.2 to 2.0 mol/l. The aqueous titanium tetrachloride solution is prepared by diluting titanium tetrachloride solution, and preferable titanium tetrachloride concentration is in the range of from 0.2 to 2.0 mol/l. The mole ratio of the barium compound/titanium compound is controlled being in the range of from 1 to 1.5, more preferably 1 to 1.1 when the aqueous solutions of barium chloride and titanium tetrachloride are added each other. A concentration of the aqueous oxalic acid solution is preferably in the range of from 0.2 to 2.0 mol/l and a temperature is maintained in the range of 20 to 100° C., more preferably 50 to 90° C.

The prepared mixture of the aqueous barium chloride and titanium tetrachloride is added by spraying into an aqueous oxalic acid solution during 1 to 3 hour period through a nozzle. The nozzle used in the present invention may be a single-fluid nozzle or double-fluid nozzle depending on fluidity, preferably single-fluid nozzle since the use of the single-fluid nozzle does not affect mole ratio of Ba/Ti and yield along with an injected amount. However, when the double-fluid nozzle using a compressed air is used, the mixture of barium chloride and titanium tetrachloride may be smogged or scattered due to the compressed air, thus resulting in lowering somewhat yield. Further, the use of double-fluid nozzle may occur aggregation in a reactor due to smogged mixture solution, thus requiring extra washing process and cost to remove such problems. Therefore, the single-fluid nozzle is preferably used compared to the double-fluid nozzle but this does not mean that the use of double-fluid nozzle is inadequate. General single-fluid nozzle such as full-con, hollow-con and flat type nozzle may be used and its size, spraying rate, or type of nozzle is applied depending on manufacturing volume, size of reactor, angle for spraying fluid, and the like.

The aging is performed for 1 to 100 hours, more preferably 0.5 to 2 hours and then the crude barium titanyl oxalate is washed with water till pH of the washer turns to neutral to produce barium titanyl oxalate.

Even though an excess mixture of aqueous barium chloride and titanium tetrachloride is sprayed in a high speed, the barium titanyl oxalate produced according to the present invention has the mole ratio of barium/titanium to be 0.999±0.001, ideally, where the ratio is stoichiometric. The method for preparing barium titanyl oxalate of the present invention is further economical due to shortened manufacturing time and high production yield.

The second step is pulverization, drying and pyrolysis of the obtained barium titanyl oxalate to produce barium titanate powder. The titanyl oxalate can be easily pulverized by methods such as dry pulverization using an atomizer, or jet mill or wet pulverization using a ball mill, planetary mill, or beads mill. This pulverization process produces barium titanyl oxalate having 0.1 to 5 μm of particle size. The pulverized barium titanyl oxalate is then dried by using oven, spray-dryer, or fuidized bed dryer.

According to the present invention, additives containing replacement element for Ba, Ti or both Ba and Ti may be added during the pulverization process. The replacement element for Ba is at least one chosen from Mg, Ca, Sr, and Pb and that of Ti is at least one chosen from Zr, Hf, and Sn. For example, an oxide, carbonate, chloride or nitrate of such a replacement element is added to the barium titanyl oxalate to produce perovskite barium titanate powder such as barium zirconate titanate, barium calcium zirconate titanate, barium calcium strontium zirconate titanate, and the like.

A rate for heating during the pyrolysis is preferably in the range of 0.5 to 10° C./min and a temperature is maintained at 700 to 1200° C.

The last step is re-pulverization of the obtained barium titanate powder. The barium titanate powder can be easily pulverized by the same methods used in the first pulverization such as dry pulverization using an atomizer, or jet mill or wet pulverization using a ball mill, planetary mill, or beads mill. Drying is performed using oven, dryer, or spray dryer only when the wet pulverization is carried.

The following examples are intended to further illustrate the present invention without limiting its scope.

Further, the scope of the present invention is not limited to barium titanate powder but includes potential barium titanate-based powders depending on kinds and contents of additives added.

### EXAMPLE 1

Preparation of Barium Titanate Using a Single-fluid Nozzle

To 4 M³ of a glass-lined reactor were added and mixed 1200 l of an aqueous 1 mol/l TiCl₄ and 1320 l of an aqueous 1 mol/l BaCl₂. The mixture was sprayed to 2520 l of an aqueous 1 mol/l oxalic acid through a single-fluid nozzle at a rate of 21 l/min. The oxalic acid solution was stirred with a rate of 150 rpm and a temperature was maintained at 90° C. A diaphr agm pump was used as a supplying pump for spraying the mixture solution. After adding the mixture to an oxalic acid for 2 hours, the mixture solution was stirred at a reaction temperature for 1 hour and at a room temperature for 1 hour to produce barium titanyl oxalate slurry. The barium titanyl oxalate slurry was filtered using a centrifuge and washed with water till pH of the washer turned to above pH 6. Yield was 98% based on Ti ion and a mole ratio of Ba to Ti was 0.999.

The barium titanyl oxalate was wet-pulverized to be 0.7 to 1.5 μm of particle size with a planetary mill to produce barium titanyl oxalate slurry, which was further dried in an oven at 120° C. for 12 hours, pyrolized at 1200° C. in an electric furnace, and dry-pulverized to produce barium titanate powder.

### EXAMPLE 2

Preparation of Barium Titanate Using a Double-fluid Nozzle

Barium titanyl oxalate was prepared by the same procedure as in Example 1, except using a double-fluid nozzle. Yield was 96% based on Ti ion and a mole ratio of Ba to Ti of barium titanyl oxalate in the wall of the reactor was 0.987 and a total mole ratio was 0.997.

Barium titanate powder was prepared by the same procedure as in Example 1.

### COMPARATIVE EXAMPLE

Preparation of Barium Titanate Employing Dropwise Addition

To 4 l of a glass-lined reactor were added and mixed 1.2 l of an aqueous 1 mol/l TiCl₄ and 1.3 l of an aqueous 1 mol/l BaCl₂. The mixture was added dropwise to 2.5 l of an aqueous 1 mol/l oxalic acid at a rate of 21 ml/min. The mixture solution was added for 2 hours while maintaining a temperature of the oxalic acid at 90° C. After adding the mixture to an oxalic acid, the mixture solution was stirred at a reaction temperature for 1 hour and at a room temperature for 1 hour to produce barium titanyl oxalate slurry. The barium titanyl oxalate slurry was filtered using a centrifuge and washed with water till pH of the washer turned to above pH 6. Yield was 80% based on Ti ion and a mole ratio of Ba to Ti was 0.921.

Barium titanate powder was then prepared by the same procedure as in Example 1.

FIG. 1 represents SEM photomicrograph of barium titanyl oxalate produced according to the above method in Comparative Example. FIG. 2 represents SEM photomicrograph of barium titanyl oxalate produced by spraying via a single-fluid nozzle in high speed, washing and filtering as in Example 1. FIG. 3 represents SEM photomicrograph of barium titanate powder produced by pyrolysis and a dry pulverization as in Example 1.

The particles of barium titanyl oxalate obtained by using nozzle spray according to the present invention exhibit no aggregation and relatively uniformed size as shown in FIG. 2 compared to the barium titanyl oxalate particles shown in FIG. 1. Further, it is noted that barium titanate powders produced according to the present invention exhibit uniformity in particle size and shape.

Scales in Examples 1 and 2, which are for pilot tests, are 1000 times more compared to that in Comparative Example. However, the yield and quality of the barium titanate powder produced in Examples 1 and 2 provides higher and better than that of the barium titanate powder produced in Comparative Example. Further, the barium titanyl oxalate obtained using a single-fluid nozzle for spray in Example 1 exhibits better yield and mole ratio of Ba to Ti than that using a double-fluid nozzle in Example 2. However, the use of double-fluid nozzle is much better than conventional dropwise addition in product yield and stoichiometry.

As described above, in the preparing process of barium titanate powder of high quality employing oxalate-derived method, which is addition of a mixture of aqueous barium chloride and titanium tetrachloride to an aqueous oxalic acid, the use of nozzle in a high speed produces barium titanate powder having uniform particle size and no aggregation in high yield and high purity. It is, therefore, suitable for as materials for multilayer ceramic capacitors, PTC thermistors, resistors, and the like.

What is claimed is:

1. A method for preparing barium titanate powder comprising the steps of:
precipitating a mixture of aqueous barium chloride and titanium tetrachloride to an aqueous oxalic acid by spraying via a nozzle in high speed, aging, washing and filtering to obtain barium titanyl oxalate;
pulverizing, drying and pyrolyzing the obtained barium titanyl oxalate to produce barium titanate powder; and
re-pulverizing the obtained barium titanate powder.

2. A method for preparing barium titanate powder of claim 1, wherein said spraying speed of the nozzle is in the range of from 0.01 to 70 l/min.

3. A method for preparing barium titanate powder of claim 1 or claim 2, wherein said nozzle used is a single-fluid type nozzle.

4. A method for preparing barium titanate powder of claim 3, wherein said single-fluid nozzle is chosen from full-con, hollow-con and flat.

5. A method for preparing barium titanate powder of claim 1, wherein a concentration of said aqueous barium chloride and titanium tetrachloride is 0.2 to 2.0 mol/l.

6. A method for preparing barium titanate powder of claim 1, wherein a mole ratio of barium chloride to titanium tetrachloride is 1 to 1.5.

7. A method for preparing barium titanate powder of claim 1, wherein a concentration of said aqueous oxalic acid is 0.2 to 2.0 mol/l.

8. A method for preparing barium titanate powder of claim 1, wherein said aging is performed for 1 to 100 hours.

9. A method for preparing barium titanate powder of claim 1, wherein an additive is used to replace Ba, Ti, or both Ba and Ti with other element during the pulverization of said barium titanyl oxalate.

10. A method for preparing barium titanate powder of claim 9, wherein said replacement element for Ba is at least one chosen from Mg, Ca, Sr, and Pb.

11. A method for preparing barium titanate powder of claim 9, wherein said replacement element for Ti is at least one chosen from Zr, Hf, and Sn.

12. A method for preparing barium titanate powder of any one of claims 9, 10, and 11, wherein said additive is chosen from chloride and nitrate of the replacement element.

13. A method for preparing barium titanate powder of claim 1, wherein a heating rate during the pyrolysis is in the range of from 0.5 to 10° C./min and a temperature is maintained at from 700 to 1200° C.
